(19) United States
(12) Patent Application Publication
(10) Pub. No.: US 2012/0317091 A1
(43) Pub. Date: Dec. 13, 2012

(54) SYSTEM AND METHOD FOR USERS TO GET NEWLY UPDATES

(76) Inventor: Luping Li, Xinyu (CN)

(21) Appl. No.: 13/156,343

(22) Filed: Jun. 9, 2011

(51) Int. Cl. G06F 17/30

(52) U.S. Cl. 707/710; 707/E17.089

(57) ABSTRACT

Most valuable newly-updated information in current social network systems and web search engines become useless before users can timely search them out. The inventive system uses the communication mechanism and the preset query mechanism to help users timely get newly updates. System components include: a web crawler, a filter and a classifier to mine public newly-updated web pages from the web; a database to store various newly updates; an integrator to collect newly updates from other sources; a controller to send newly updates to corresponding users; a query box to store each user's preset queries and manager users' preferences; a communication platform to help users easily get preset queries. The method can help current social network systems and web search engines make better use of their newly updated data. Web search engines can better cooperate with social networks by using the method.

### BACKGROUND OF THE INVENTION

Systems such as social networks and web search engines contain lots of newly-updated information. The social network users produce lots of updates. They write news articles, do social updates and post blogs about hot topics around the world. Web search engines update frequently and some of them have cooperation with social network systems. These web search engines are able to collect newly-updated information from various sources, such as updates from web pages and updates from social networks. For example, Google and Bing have cooperation with Twitter. They can integrate updates in Twitter to their original results. Users can search newly-updated information in Google's real time search engine or in the “Bing box”.

Unfortunately, the web search engine users often suffer from two problems. One problem is that users may not submit their queries in time thus newly updates would become useless. For example, Macy's registered a Twitter account to publish news for its stores; a user is interested in discount events and submits the query “Macy's Discount” to Google's real-time search engine, only to find that Macy's just held a discount event yesterday in a store nearby. Another problem is that, the web search engine users cannot communicate with each other and a single user can only think out queries based on the user's own limited knowledge. So it's not easy and thus takes a long time for a singer user to think out a good query that can lead to useful newly-updated information in web search engines.

The social network users also have troubles in getting and sharing newly updates: (a) most newly updates are shared within individual networks (the inventive system's users can get interested updates posted by someone that they don't even know exists); (b) users receive all newly updates from a friend, even if some of those updates are not of interest; (c) users who search updates in social networks often suffer from the same two problems with the web search engine users, since searching in social networks only plays a helpful role while communication plays a main role (the reverse is true in the inventive system) and users seldom share queries in social networks.

Because of the above reasons, most public updates in systems like social networks and web search engines become useless before users can timely search them out. This is a big waste! There is a need for a system that can prevent this waste and make full use of the newly updates.

### SUMMARY OF THE INVENTION

It is an object of the invention to make full use of newly-updated information collected from various sources. The system contains a set of components to crawl updates from the web and has an integrator to collect updates from other sources. The communication mechanism lets users in the system share preset queries and newly-updated information with each other. Users even don't need to think out queries by themselves, since the system will constantly generate preset queries (frequent patterns) and share them on the communication platform. They can easily find interesting preset queries on the communication platform and add them to their query boxes.

The preset query mechanism lets the system timely forward newly-updated information to corresponding users according to the preset queries in their query boxes. The system's users can benefit a lot from this service. For example, a user is interested in discount events and adds “Macy's Discount” in the query box; the user will not miss Macy's discount events any more, since once Macy's posts an update, the system would find a mapped preset query in the query box and the update will be sent to the user immediately. The method can help social network systems and web search engines make better use of their newly updated data. Web search engines can better cooperate with social networks by using the method.

### BRIEF DESCRIPTION OF THE SEVERAL VIEWS OF THE DRAWING

FIG. 1 a block diagram showing the structure of the system

FIG. 2 is a diagrammatic illustration showing the preset queries published by the system 10 and users 11 on the communication platform 8 of FIG. 1

FIG. 3 is a diagrammatic illustration showing the user's preset queries and interested web sites in the query box 12; the user will get related newly updates 13 sent by the controller 6 of FIG. 1

FIG. 4 is a diagrammatic illustration showing the newly-updated information 14 shared by users and hot updates 15 sent by the controller 6 of FIG. 1

FIG. 5 and FIG. 6 is a diagrammatic illustration showing how a user gets a related update

20 of FIG. 7 is a diagrammatic illustration showing the login screen of the system

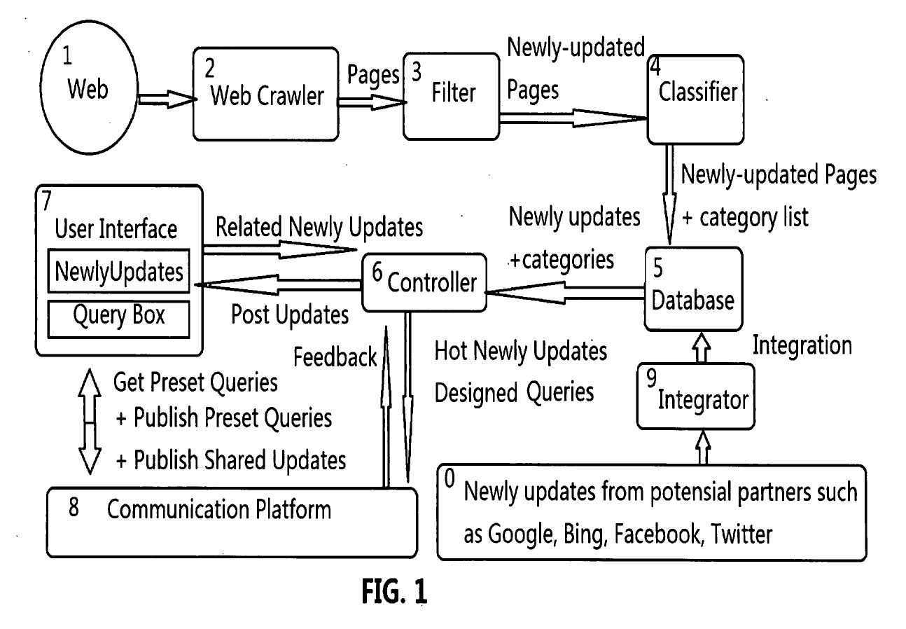

21 of FIG. 7 is a diagrammatic illustration showing Macy's is editing an update which will be sent to mapped users via the controller 6 of FIG. 1

### DETAILED DESCRIPTION OF THE INVENTION

The present invention will be further illustrated with embodiments below. However, the present invention is not limited to the following embodiments, FIG. 1 shows the structure of the system. The system uses a web crawler (2 of FIG. 1) as a means of providing up-to-date data. Traditional web crawlers start with a list of URLs to visit; and as the crawlers visit these URLs, they identify all the hyperlinks in the page and add them to the list of URLs to visit (called the crawl frontier); URLs from the frontier are recursively visited according to a set of policies. The large volume of the web implies that traditional crawlers can only download a fraction of the web pages within a given time, so some web pages might have already been updated or even be deleted.

To alleviate this problem, the system's crawler focuses on downloading pages of frequently updated web sites. It starts with a long list of URLs, each URL belongs to a different web site that frequently updates its pages; and as the crawler visits these URLs, it identifies all the hyperlinks in the page and adds those that belong to the same web site with the page to the list of URLs to visit.

The filter (3 of FIG. 1) in the system checks the update time of each web page with the current system time and only sends newly updated pages to the system's classifier (4 of FIG. 1). The classifier is used to identify the category of each page. Popular categories include celebrities, cities, companies, musicians, movies, places, and sports. The contents of each web page are then analyzed to determine how it should be indexed and stored in the database (5 of FIG. 1). Data in the database will be deleted once they become out-of-date. The system's integrator (9 of FIG. 1) is used to integrate other newly updates (0 of FIG. 1) into the system's original data.

Each user has a query box (7 of FIG. 1) that is used to store preset queries created by the corresponding user or chosen from the communication platform by the corresponding user. The query box also contains a user's interested web sites and preference information. The data in query boxes are sent to the controller (6 of FIG. 1). The controller uses the data to create several inverted indexes. Each inverted index stores a mapping from a piece of preference information to a list of users. To help users get interested updates, the controller is responsible for solving at least two problems: (1) the ambiguity of preset queries; (2) users can define their own preference setting so different users may have different preference on the answers to be found.

The processing of the controller will be described stepwise.

(A) The controller fetches newly updates from the database; and it searches the created inverted indexes to find matched users for each fetched update; it then sends fetched updates to corresponding users.

(B) A user adds a new preset query to the corresponding query box; the preset query will be sent to the controller; the controller then updates the inverted indexes and searches the database to find matched updates for the preset query; matched updates will be sent to the user.

(C) A user posts an update; the update will be fetched by the controller; the controller then searches the created inverted indexes to find matched users for the update; finally the controller sends the update to corresponding users.

(D) The controller decides the popularity of an update by measuring the number of matched users of the update. Popular updates will be shared on the communication platform (15 of FIG. 4).

(E) In order to let more users timely know fetched updates, the controller mines frequent patterns (preset queries that can lead to up-to-date updates in the system) from the fetched updates. The frequent patterns will be shared on the communication platform.

The communication platform lets users easily share preset queries and updates. A user can publish a search intention or a rough preset query that cannot lead to interested updates on the platform so that others can comment it and help to create a good preset query. A user can also publish a good preset query on the platform directly so that others can benefit from it. The system's users don't have to think out preset queries by themselves; they can use preset queries (frequent patterns) designed by the controller to get up-to-date updates. The main purpose of the communication platform is to share preset queries so that users can easily get various newly updates. Searching in the system plays a main role while communication plays a helpful role. The reverse is true in social network systems.

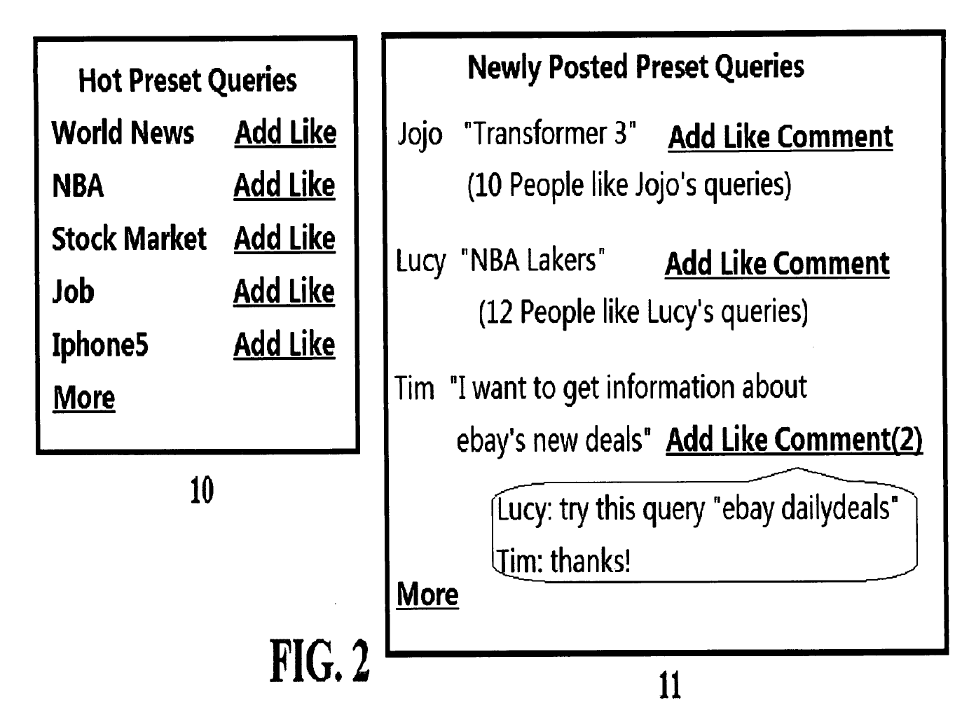

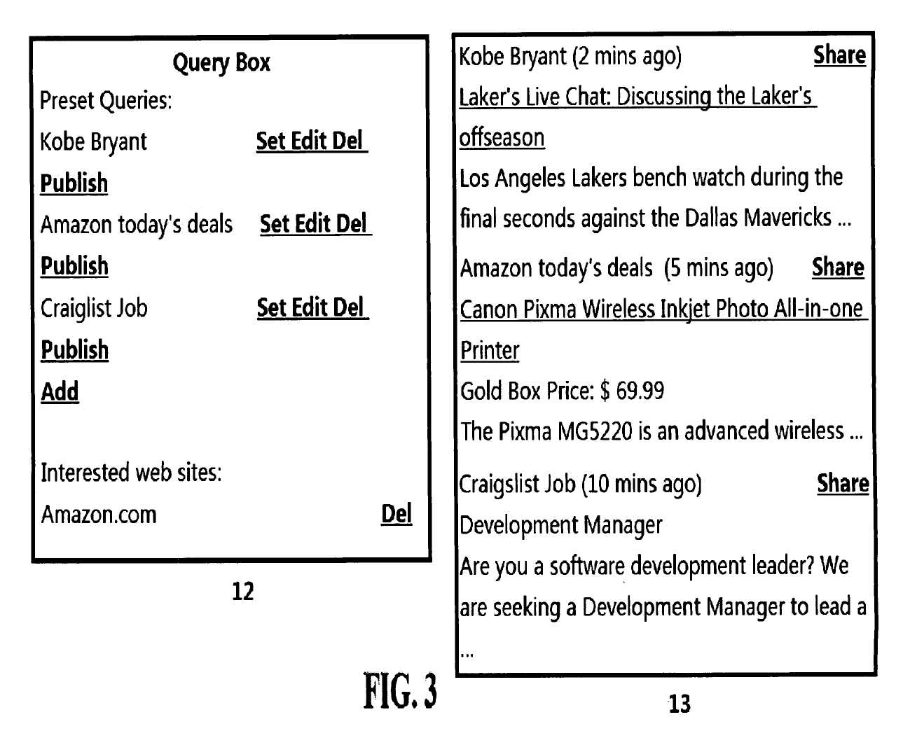

10 of FIG. 2 is an example to show the preset queries designed by the system's controller. These preset queries are frequent patterns mined from fetched updates. Users can add these preset queries to their query boxes. 11 of FIG. 2 shows the preset queries published by users. A special example is that Tim is interested in getting information about eBay's new deals and Lucy suggests him try the preset query “eBay daily deals”.

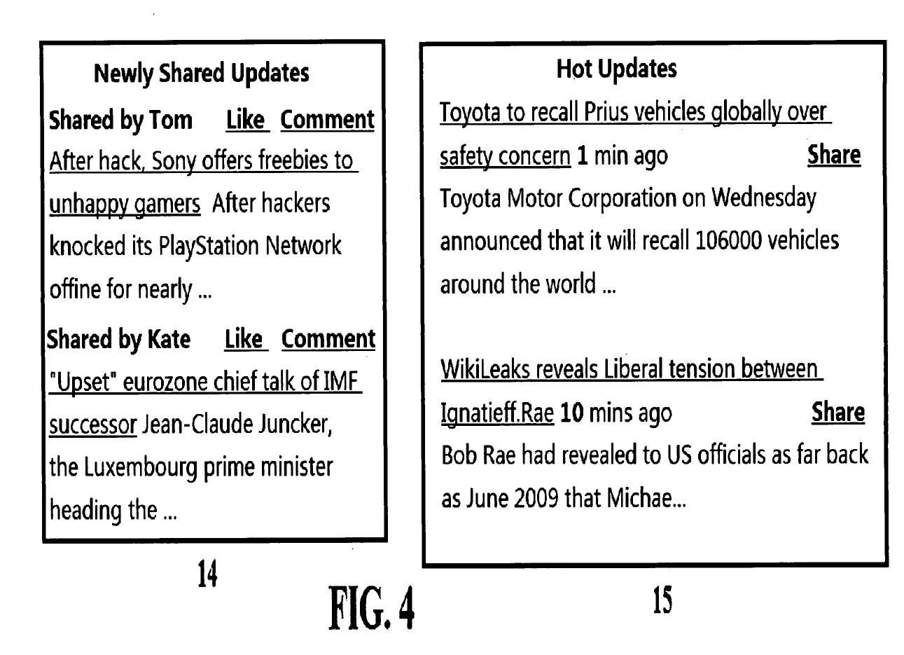

12 of FIG. 3 is a diagrammatic illustration showing the user's query box. The user can add, delete or publish a preset query there. The user can also set personal preference for each preset query. The default settings include preferred web sites, categories of updates and expired time. 13 of FIG. 3 shows the user receiving corresponding updates sent by the controller. The user can share interesting updates with others.

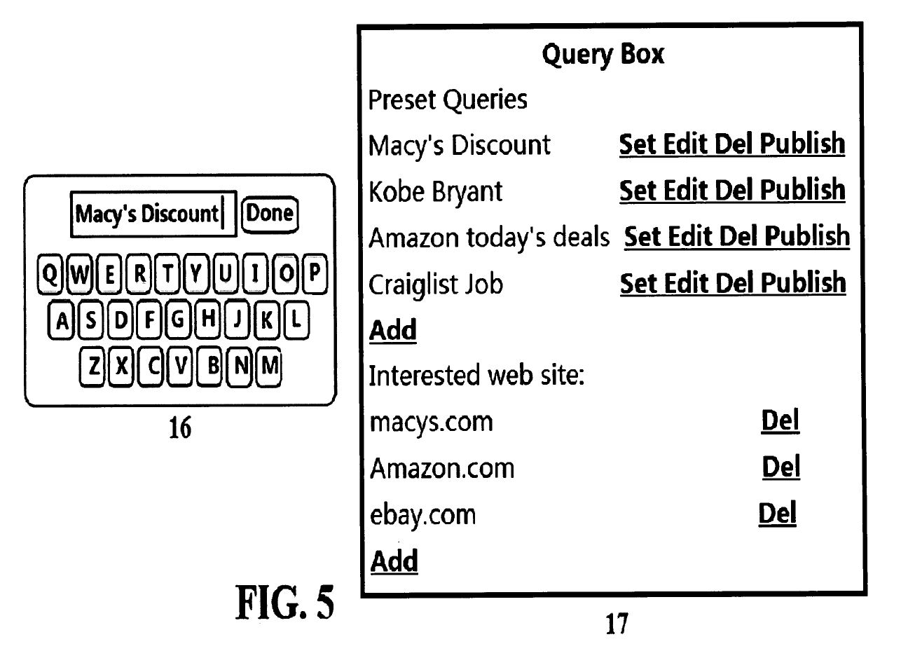

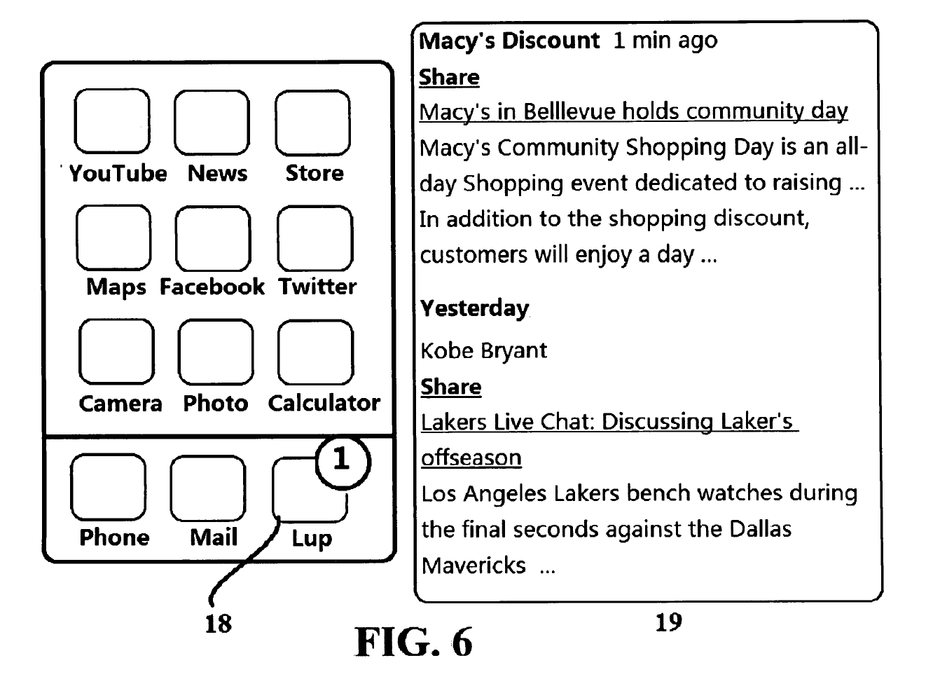

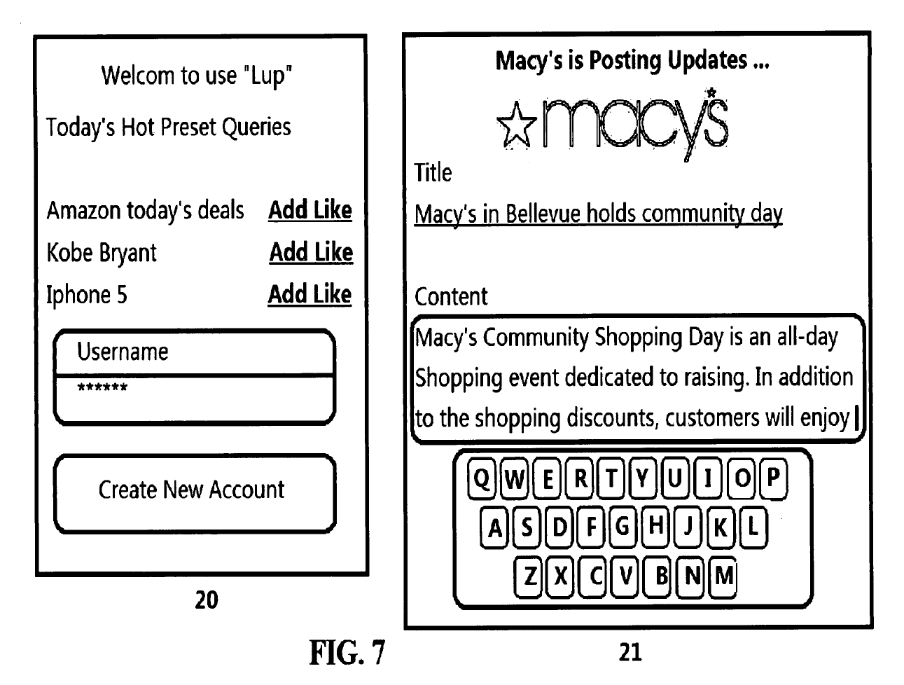

FIG. 5 is a diagrammatic illustration showing a user creating a preset query “Macy's Discount” 16 and add it to the query box 17; and after a while, as shown in FIG, 6, the user receives a corresponding update from Macy's.

An unregistered user can browse hot preset queries (20 of FIG. 7), updates shared by registered users (14 of FIG. 4) and updates published by the system (15 of FIG. 4).

Users in the system can post update (21 of FIG. 7). The posted updates will be sent to all mapped users in the system. Different from current soda networks, (1) the inventive system's users can get interested updates posted by people they don't even know exists; and (2) they don't have to read the all updates posted by a friend.

The present invention is described by way of particular embodiments. However, the present invention is not limited to the embodiments, and those skilled in the art could perform modification of the invention within the scope of the invention such as addition, change, or omission as the other embodiments. Any embodiment that can realize operations and advantages of the present invention is encompassed in the scope of the present invention.

I claim:

1. A method for users to get newly updates, said method comprising the steps of:
(a) storing updated information in a database;
(b) providing each registered user with a query box adapted to store preset queries;
(c) storing the preset queries created by each user in the corresponding query box;
(d) providing a communication platform adapted to share information, wherein the information comprise preset queries;
(e) adding the preset queries chosen from the communication platform by each registered user to the corresponding query box;
(f) creating at least one index for data in the query boxes, wherein the data comprise preset queries;
(g) fetching updated information, said updated information coming from updates stored in the database or updates posted by registered users;
(h) using the created index to find registered users for each fetched update; and
(i) sending the fetched updates to corresponding registered users.

2. The method of claim 1, wherein a preset query comprises at least one word.

3. The method of claim 1, wherein information shared on the communication platform come from preset queries published by registered users or frequent patterns mined from fetched updates.

4. A system for users to get newly updates, the system comprising:
(a) a database adapted to store updated information;
(b) a query box for each registered user, adapted to store preset queries;
(j) a communication platform adapted to share information, wherein the information comprise preset queries;
(c) a control unit, said control unit being adapted to
create at least one index for data in the query boxes,
fetch updated information from the database,
fetch updates posted by registered users,
mine frequent patterns from the fetched updates,
share frequent patterns on the communication platform,
use the created index to find registered users for fetched updates, and
send fetched updates to corresponding registered users.

5. The system of claim 4, wherein a preset query comprises at least one word.

6. The system of claim 4, wherein information shared on the communication platform come from preset queries published by registered users or frequent patterns mined from fetched updates.

7. The system of claim 4, wherein data in the query boxes comprise preset queries.
